(19) United States
(12) Patent Application Publication
(10) Pub. No.: US 2002/0191117 A1
(43) Pub. Date: Dec. 19, 2002

(54) Frequency conversion circuit, demodulation circuit, and television receiving device

(76) Inventors: Yoshikatsu Matsugaki, Oita (JP); Akinobu Morota, Ohita (JP)

Correspondence Address: TEXAS INSTRUMENTS INCORPORATED, P O BOX 655474, M/S 3999, DALLAS, TX, 75265

(21) Appl. No.: 10/105,541

(22) Filed: Mar. 25, 2002

(30) Foreign Application Priority Data
Mar. 27, 2001 (JP) 2001-090356

(51) Int. Cl. H04N 5/455

(52) U.S. Cl. 348/726

(57) ABSTRACT

A demodulation circuit that does not produce Nyquist buzzing. After IF signals output by bandpass filter (16) are multiplied by first and second multipliers (31) and (32) with a carrier wave reproduced by carrier wave reproduction part (7) and a carrier wave whose phase is shifted π/2, respectively, they are squared by first and second square-law circuits (33) and (34) and added together by addition adder (35). The error produced by the Nyquist slope is removed from the output of adder (35).

### FIELD OF THE INVENTION

Technical field to which the invention belongs

This invention pertains to the technical field of demodulation circuits. In particular, it pertains to a frequency conversion circuit, a demodulation circuit, and a television receiving device suitable for high-quality reproduction of the secondary audio included in TV signals.

### BACKGROUND OF THE INVENTION

TV signals transmitted from a broadcasting station and received by a television receiver generally undergo AM demodulation. Thus TV signals must be AM demodulated into video signals and audio signals by the television receiving device.

Intercarrier System

A television receiving device using an intercarrier system circuit, from among conventional television receiving devices, is shown in FIG. 4. The television receiving device 101 has receiving circuit 120 and demodulation circuit 105.

Receiving circuit 120 has tuner 103 and bandpass filter 104. RF signals transmitted from a broadcasting station are received by tuner 103 via antenna 102, they are frequency converted by said tuner 103, and output as IF (intermediate frequency) signals.

IF signals includes both VIF signals (Video IF signals: in Japan, they are 58.75 MHz) and SIF signals (Sound IF signals: in Japan, they are 54.25 MHz.).

The IF signals are input to bandpass filter 104 and only signals of a prescribed band frequency pass through and are input to demodulation circuit 105.

Demodulation circuit 105 has IF amp 106, carrier wave reproduction part 107, multiplier 108, and signal demodulation part 109.

The voltage of IF signals input to demodulation circuit 105 is amplified by IF amp 106 and output to both carrier wave reproduction part 107 and multiplier 108.

Carrier wave reproduction part 107 has multiplier 110, low-pass filter 111, and voltage-controlled oscillator 112. These constitute a PLL circuit. IF signals output to carrier wave reproduction part 107 from IF amp 106 are input to multiplier 110 and, at the spot where the oscillation frequency of voltage-controlled oscillator 112 agrees with the frequency of the carrier wave included in the IF signals due to the operation of PLL loop, the frequency of the local signal output by voltage-controlled oscillator 112 is stabilized.

The local signal output by voltage-controlled oscillator 112 is input to phase shifter 113 and input to multiplier 108 after its phase is shifted π/2.

Both the signals output by phase shifter 113 and the IF signals output from IF amp 106 are input to multiplier 108. The input signals are multiplied by each other inside multiplier 108 and a multiplied signal is generated and output to signal demodulation part 109.

Signal demodulation part 109 is furnished with low-pass filter 114 and audio demodulation part 119. The multiplied signals output from multiplier 108 are input to both low-pass filter 114 and audio demodulation part 119.

Low-pass filter 114 removes higher harmonic components from the input multiplied signals and a video signal is ultimately extracted.

Bandpass filter 115, audio FM demodulation part 116, and audio multiplexing part 117 are furnished inside audio demodulation part 119. The multiplied signals output by multiplier 108 are input to bandpass filter 115.

When a multiplied signal is generated inside multiplier 108, the SIF signals included in the IF signals are converted to IF signals with a lower frequency (normally 4.5 MHz). When the multiplied signal output by multiplier 108 passes through bandpass filter 115, audio IF signals are produced and input to audio FM demodulation part 116. Audio demodulation part 116 FM modulates the input audio IF signals and outputs them to audio multiplexing part 117.

Audio multiplexing part 117 performs further FM demodulation of the secondary audio and selects and outputs either primary audio, secondary audio, or stereo according to the external control.

Symbol 102 in FIG. 5 is a television receiving device that uses a split carrier system circuit from the prior art. The same symbols are assigned to the same parts as intercarrier system television receiving device 101 and explanations will be omitted.

With split carrier system television receiving device 102, IF signals output from tuner 103 are separated by frequency into VIF signals and SIF signals by bandpass filter 104′.

From the separated signals, the VIF signals are processed the same way as with intercarrier system television receiving device 101 and video signals are produced.

On the other hand, the SIF signals are amplified by SIF amp 122 and then output to multiplier 123.

Multiplier 123 multiplies the input SIF signals and local signals output by phase shifter 113. In this way the SIF signals are frequency converted to the IF signals with a lower frequency (normally 4.5 MHz) and are output to audio demodulation part 119. Audio demodulation part 119 operates the same way as the aforementioned and produces audio signals.

With the demodulation circuits 105 and 105′ of the aforementioned two systems, local signals output from carrier wave generation part 107 are used as reproduced carrier waves and the SIF signals are frequency converted to low frequency IF signals (normally 4.5 MHz). With this method, a high signal purity as shown in FIG. 6 is required for the local signals.

However, the signal purity of the VIF signals decreases as below because of the TV signal characteristics and the characteristics of bandpass filter 104.

FIG. 7 (a) is a schematic diagram of the spectrum of a TV signal. Most of the frequencies lower than carrier wave frequency f_{c}, in the TV signal signals transmitted by a broadcast station are removed to increase frequency usage efficiency.

When the portions of frequencies lower than carrier wave frequency f_{c} are removed in this way, it is difficult to sharply cut out frequency portions lower than carrier wave frequency f_{c}Signals that pass through bandpass filter 104 have a slope, and as the frequency becomes lower, their strength gradually decreases. This slope is called the Nyquist slope.

This Nyquist slope produces Nyquist buzz as below and is the source of noise in secondary audio.

An AM modulated TV signal wave is shown in Formula (1) below. For simplicity, the phase difference of the initial phase of the carrier wave, the carrier wave, and the modulated wave is considered to be zero.

$$\begin{matrix}AM wave ( DSB modulation ) = {A}_{c} \{ 1 + m cos ( 2 {f}_{m} t ) \} cos ( 2 {f}_{c} t ) \\ = {A}_{c} cos ( 2 {f}_{c} t ) + \\ ( m \cdot {A}_{c} / 2 ) cos \{ 2 ( {f}_{c} - {f}_{m} ) t \} + \\ ( m \cdot {A}_{c} / 2 ) cos \{ 2 ( {f}_{c} + {f}_{m} ) t \}\end{matrix} \qquad ( 1 )$$

Here, A_{c}cos(2πf_{c}t) represents the carrier wave, cos(2πfₘt) represents the modulated wave, A_{c} represents the amplitude of the carrier wave, f_{c} represents the frequency of the carrier wave, m represents the degree of modulation, and fm represents the modulation frequency.

DSB is the abbreviation of Double Side Band and means the same thing as amplitude modulation. It is used to differentiate from the normal television modulation system (AM VSB modulation).

First, we will consider the effect on carrier wave reproduction part 107 by VSB modulated waves.

High frequency components are removed by low-pass filter 111 at carrier wave reproduction part 107, so the effect of the flat part in FIG. 7 (b) (the frequency components separated from carrier wave frequency f_{c},) can be ignored.

Thus, when only the function of carrier wave reproduction part 107 is considered, only near carrier wave frequency f_{c}, in FIG. 7 (b) need be considered. The frequency band in this case is shown in FIG. 7 (c). A VSB wave with such a spectrum can be represented as in Formula (2) below.

$$\begin{matrix}VSB wave = ( {A}_{c} / 2 ) cos ( 2 {f}_{c} t ) + \\ ( {A}_{c} \cdot m / 4 ) ( 1 - {f}_{m} B ) cos \{ 2 ( {f}_{c} - {f}_{m} ) t \} + \\ ( {A}_{c} \cdot m / 4 ) ( 1 + {f}_{m} \cdot B ) cos \{ 2 ( {f}_{c} + {f}_{m} ) t \} \\ = ( {A}_{c} / 2 ) cos ( 2 ( {f}_{c} t ) + ( {A}_{c} \cdot m / 4 ) cos \{ 2 ( {f}_{c} - {f}_{m} ) t \} + \\ ( {A}_{c} \cdot m / 4 ) cos \{ 2 ( {f}_{c} + {f}_{m} ) t \} - \\ ( {A}_{c} \cdot m \cdot {f}_{m} \cdot B / 4 ) [ cos \{ 2 π ( {f}_{c} - fm ) t \} - \\ cos \{ 2 π ( {f}_{c} + {f}_{m} ) t \} ] \\ = ( {A}_{c} / 2 ) [ \{ 1 + m cos \{ 2 π {f}_{m} t ) \} ] cos ( 2 π {f}_{c} t ) - \\ ( {A}_{c} \cdot m \cdot {f}_{m} \cdot B / 2 ) sin ( 2 π {f}_{m} t ) sin ( 2 π {f}_{c} t )\end{matrix} \qquad ( 2 )$$

Here, B is a constant determined by the incline (Nyquist slope) in FIG. 7 (c). In the NTSC (National Television System Committee) it is about 5×10⁻⁷.

The signals in aforementioned Formula (2) are multiplied by the local signal (sin (2πf_{c},t+θε the by multiplier 110, and they are output to voltage-controlled oscillator 112 after the high frequency components are removed by low-pass filter 111.

Here θ_{ε}is the phase difference between the modulated wave output by IF amp 106 and the reproduced carrier wave output by voltage-controlled oscillator 112. It is normally called the phase error.

Below, if calculation is performed assuming that phase error θ_{ε}is 0, the output of multiplier 110 is represented by Formula (3) below.

VSB ·sin (2πf_{c}t)

$$\begin{matrix}VSB \cdot sin ( 2 π {f}_{c} t ) = ( {A}_{c} / 2 ) [ \{ 1 + m cos ( 2 π {f}_{m} t ) \} ] cos ( 2 π {f}_{c} t ) sin ( 2 π {f}_{c} t ) - \\ ( {A}_{c} \cdot m \cdot {f}_{m} \cdot B / 2 ) sin ( 2 π {f}_{m} t ) sin ( 2 π {f}_{c} t ) sin ( 2 π {f}_{c} t ) \\ = ( {A}_{c} / 4 ) [ \{ 1 + m cos ( 2 π {f}_{m} t ) \} ] sin ( 4 π {f}_{c} t ) - \\ ( {A}_{c} \cdot m \cdot {f}_{m} \cdot B / 4 ) sin ( 2 π {f}_{m} t ) \cdot \{ 1 - cos ( 4 π {f}_{c} t ) \}\end{matrix} \qquad ( 3 )$$

When signals represented by aforementioned Formula (3) pass through low-pass filter 111, the high frequency components cos(4πf_{c}t) and sin(4πf_{c}t) are removed. The result is that the signal obtained by Formula (4) below is output from low-pass filter 111.

(output of low-pass filter 111)=−(A_{c}·m·fₘ·B/4) sin (2πfₘt) . . . (4)

When there is a Nyquist slope, B will not be zero. So this means that with aforementioned Formula (4), when phase error θ_{ε}is 0, that is, even when the PLL loop is locked, a modulated wave component represented by sin (2πfₘt) is input to voltage-controlled oscillator 112.

Voltage-controlled oscillator 112 oscillates based on the input voltage, so if the input voltage is not DC and contains no modulated wave components, it generates FM modulates signals.

An example of the FM modulated output signal from voltage-controlled oscillator 112 is shown in FIG. 8. In FIG. 8, side lobes appear every fₕ(horizontal synchronous signal: 15 kHz) at both sides of the main lobe (carrier wave frequency f, positioned in the center).

This is because video signals often have frequency components that are whole number multiples of frequency fₕ of the horizontal synchronous signal.

When side lobes such as the aforementioned are included in the local signals output from voltage-controlled oscillator 112, the FM modulated audio signals are affected.

For example, in the case of audio signals in accordance with NTSC format, as shown in FIG. 9, the primary audio part is not affected by the side lobes of the local signals, but the secondary audio is obtained by FM modulating a secondary carrier wave with a frequency exactly two times fₕ. So this secondary carrier wave will be affected by the second (±2×fₕdetuning) from the center in FIG. 8 (considered the 0^{th}). The result will be expressed as buzzing when the secondary audio or stereo is received. This is Nyquist buzzing.

This phenomenon occurs in theory when the output of carrier wave reproduction part 107 that is affected by the VSB wave is used for a local signal for frequency conversion of audio IF signals. So it cannot be avoided with the intercarrier system of the split carrier system as shown in FIG. 5.

This invention was devised to solve the aforementioned problems with the conventional art. Its purpose is to provide a frequency conversion circuit, demodulation circuit, and television receiving device that does not produce Nyquist buzz.

### SUMMARY OF THE INVENTION

In accordance with one aspect of the invention, the frequency conversion circuit has: an input terminal into which are input input signals that have a first frequency signal and a second frequency signal, a reference signal generation circuit into which the aforementioned input signals are input and that generates a first reference signal that has the same frequency as the aforementioned first frequency signal and a second reference signal whose phase is shifted π/2 from the aforementioned first reference signal, a first multiplication circuit that multiplies the aforementioned input signal and the aforementioned first reference signal to output a first multiplied signal, a second multiplication circuit that multiplies the aforementioned input signal and the aforementioned second reference signal to output a second multiplied signal, a first square-law circuit that squares the aforementioned first multiplied signal to output a first square-law signal, a second square-law circuit that squares the aforementioned second multiplied signal to output a second square-law signal, and an addition circuit that adds the aforementioned first square-law signal and the aforementioned second square-law signal to output an addition signal.

According to another aspect of the invention the demodulation circuit of this invention has an input terminal into which an intermediate frequency signal that has a video signal and an audio signal, a carrier wave signal generation circuit into which the aforementioned intermediate frequency signal is input to generate a first reference signal that has the same frequency as the carrier wave included in the aforementioned intermediate frequency signal and a second reference signal whose phase is shifted π/2 from the aforementioned first reference signal, a first multiplication circuit that multiplies the aforementioned intermediate frequency signal and the aforementioned first reference signal to output a first multiplied signal, a second multiplication signal that multiplies the aforementioned intermediate frequency signal and the aforementioned second reference signal to output a second multiplied signal, a first square-law circuit that squares the aforementioned first multiplied signal to output a first square-law signal, a second square-law circuit that squares the aforementioned second multiplied signal to output a second square-law signal, an addition circuit that adds the aforementioned first square-law signal and the aforementioned second square-law signal to output an addition signal, and an audio signal demodulation part into which the aforementioned addition signal is input to demodulate the audio signal.

According to a further aspect of the invention, the carrier wave signal generation circuit has a voltage-controlled oscillator that generates the aforementioned first reference signal, a multiplier that multiplies the aforementioned intermediate frequency signal and the aforementioned first reference signal, a low-pass filter into which the output signal of the aforementioned multiplier is input and that outputs to the aforementioned voltage-controlled oscillator, and a phase shifter that generates the aforementioned second reference signal from the aforementioned first reference signal.

A still further aspect of the invention includes a television receiving device having a tuner into which television signals are input, a bandpass filter into which the output signals of the aforementioned tuner are input to output intermediate frequency signals, an amplification circuit that amplifies the intermediate frequency signals output from the aforementioned bandpass filter, and the above-mentioned demodulation circuit into which the output signals of the aforementioned amplification circuit are input.

According to aspects of this invention, constituted as described above, the phase of signals output from the first and second multiplication circuits is shifted π/2, and items containing the effects of the Nyquist slope are eliminated by adding them after squaring. Thus signals output from the addition circuit are not affected by the Nyquist slope, and audio signals without any Nyquist buzz can be obtained. High-quality demodulation can be achieved.

### BRIEF DESCRIPTION ON THE DRAWINGS

FIG. 1

Demodulation circuit that is an embodiment of the invention and a television receiving device using that demodulation circuit.

FIG. 2

Another example of a demodulation circuit of this invention and a television receiving device using that demodulation circuit.

FIG. 3

Still another example of a demodulation circuit of this invention and a television receiving device using that demodulation circuit.

FIG. 4

Circuit diagram of a conventional television receiving device.

FIG. 5

Circuit diagram of another example of a conventional television receiving device.

FIG. 6

Graph of a local signal with high signal purity.

FIG. 7

(a)-(c): Figures of video signal spectrum characteristics.

FIG. 8

Graph of a local signal that includes side lobes.

FIG. 9

Graph for illustrating the effect of side lobes on the audio signal.

### REFERENCE NUMERALS AND SYMBOLS AS SHOWN IN THE DRAWINGS

In the figures, (1), (1a), (1b) represents a television receiving device, (4), (4a), (4b) represents a demodulation circuit; (7) represents a carrier wave reproduction part, (16) represents a bandpass filter, (24) represents a phase shifter, (31), (32) represents a first and second multiplier (33), (34) represents a first and second square-law circuit, and (35) represents an addition circuit.

### DESCRIPTION OF THE EMBODIMENTS

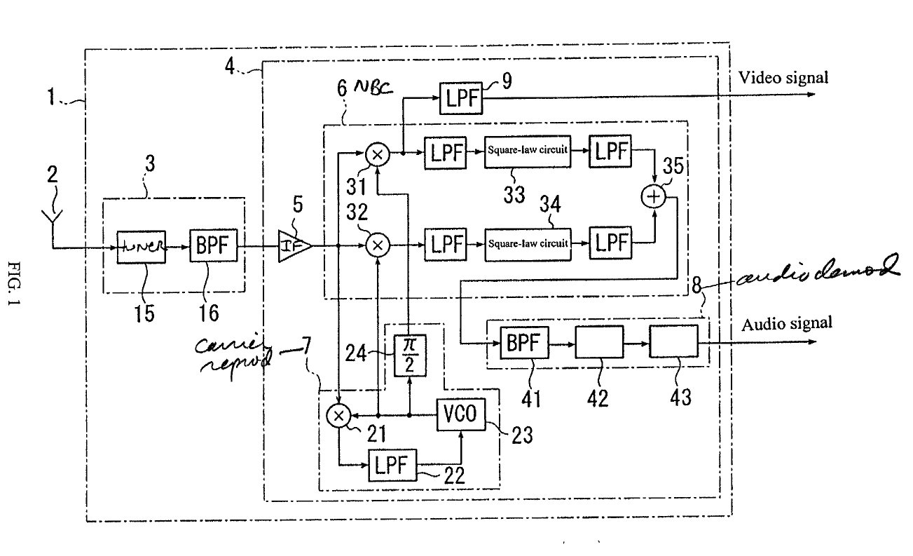

An embodiment of this invention will be explained using the figures. Symbol (4) in FIG. 1 is an example of a demodulation circuit of this invention. Symbol (1) represents a television receiving device that has demodulation circuit (4) and receiving circuit (3).

Receiving circuit (3) has tuner (15) and bandpass filter (16). RF signals (TV signals) input through antenna (2) are received by tuner (15), and after frequency conversion into IF (intermediate frequency) signals, are output to bandpass filter (16).

Bandpass filter (16) is a filter for passing only set frequency bands and it removes signals of a lower frequency than the carrier wave frequency f_{c} contained in the IF signals from the input IF signals and outputs them to later-stage demodulation circuit (4). Frequencies that are lower than carrier wave frequency f_{c} are not completely removed by bandpass filter (16) as discussed above, and the output signals include the Nyquist slope.

Demodulation circuit (4) has IF amp (5), NBC circuit (Nyquist buzz canceller circuit) (6), carrier wave reproduction part (7), audio demodulation part (8), and output low-pass filter (9).

IF signals output from bandpass filter (16) are input to IF amp (5) inside demodulation circuit (4) and are output to NBC circuit (6) and carrier wave reproduction part (7) after being amplified.

Carrier wave reproduction part (7) has multiplier (21), low-pass filter (22), VCO (voltage- controlled oscillator) (23), and phase shifter (24).

Multiplier (21), low-pass filter (22), and VCO (23) constitute a closed loop. IF signals output from IF amp (5) and local signals output from VCO (23) are input to multiplier (21).

Multiplier (21) multiplies the two input signals and outputs to low-pass filter (22). Higher harmonic signals produced as a result of multiplication are removed at low-pass filter (22) and the filtered signals are input to VCO (23).

VCO (23) oscillates at a frequency according to the voltage value of the input signals and outputs a local signal at that frequency. The local signal is input to multiplier (21), it is multiplied with the IF signal in the aforementioned way and is returned to VCO (23) through low-pass filter (22).

A PLL loop is constituted by the closed loop of multiplier (21), low-pass filter (22), and VCO (23) like that above, and the frequency of the local signals output by the VCO is stabilized at the spot where the oscillation frequency of the output signals of VCO (23) is equal to the frequency of the carrier wave f_{c} included in the IF signal.

NBC circuit (6) has first and second multipliers (31) and (32), first and second square-law circuits (33) and (34), and addition circuit (35).

The output signal of VCO (23) is directly input to second multiplier (32) and is also input to first multiplier (31) after its phase is shifted π/2 by phase shifter (24).

In addition to the signals output by carrier wave reproduction part (7), the IF signal output by IF amp (5) is also input to both first and second multiplier circuit (31) and (32). The local signal input from VCO (23) and the IF signal input from IF amp (5) are multiplied by second multiplier (32) and is output to second multiplication circuit (34).

The local signal input from phase shifter (24) and the IF signal input from IF amp (5) are multiplied by first multiplier (31) and output to first square-law circuit (33) and output low-pass filter (9).

Here, the IF signal includes a carrier wave, a VIF signal, and an SIF signal, but if the VIF signal is omitted, the IF signal can be represented as in Formula (5) below.

IF=A_{c}cos(2πf_{c}t)+Aₛcos{2π(f_{c}−fₛ)t} (5)

A_{c}, is the carrier wave amplitude of the VIF signal, f_{c} is the carrier wave frequency of the VIF signal, Aₛis the carrier wave amplitude of the SIF signal, and (f_{c}−fₛ) is the carrier wave frequency of the SIF signal.

Letting LO_{Q} represent the local signal output by VCO (23) and letting LO_{I}represent the local signal output by phase shifter (24), since the phase of the other local signal LO_{I}is shifted π/2 relative to the one local signal LO_{Q}, each can be represented by Formulas (6) and (7) below, respectively.

LO₁=cos(2πf_{c}t+θε) (6)

LO_{Q}=sin(2πf_{c}t+θε) (7)

Here, θε is the phase error. Phase error θε is not a constant but is a periodic function that has frequency components of 15.75 kHz (=fₕ) and whole number multiples thereof.

Local signals LO_{I} and LO_{Q} are multiplied by the IF signal by first and second multipliers (31) and (32). Letting the signal output by first multiplier (31) be represented by the symbol I,

I=IF×LO₁=[A_{c}cos(2πf_{c}t)+Aₛcos{2π(f_{c}−fₛ)t}]×cos(2πf_{c}t+θε)=(A_{c}/2){cos(2π2f_{c}t+θε)+cos(θε)}+(Aₛ/2)[cos{2π(2f_{c}−fₛ)t+θε}]+cos(−2πfₛt−θε)]

If frequencies above 2f_{c} are removed by the low-pass filter,

I\mathring{R}(A_{c}/2)cos(θε)+(Aₛ/2)cos(−2πfₛt−θε) =(A_{c}/2)cos(θε)+(Aₛ/2)cos(2πfₛt+θε) (8)

Letting the signal output by second multiplier (32) be represented by symbol Q in the same way,

Q=IF×LO_{Q}=[A_{c}cos(2πf_{c}t)+Aₛcos{2π(f_{c}−fₛ)t}]×si n(2πf_{c}t+θε)\mathring{R}(A_{c}/2)sin(θε)+(Aₛ/2)sin(2πfₛt+θε) (9)

After signal I and signal Q are squared by first and second square-law circuits (33) and (34), respectively, they are added by addition circuit (35). The signal output from addition circuit (35) (I²+Q²) from aforementioned Formulas (8) and (9) is

$$\begin{matrix}{I}^{2} + {Q}^{2} = {( {A}_{c} / 2 )}^{2} \{ {cos}^{2} ( θ ϵ ) + {sin}^{2} ( θ ϵ ) \} + \\ {( {A}_{s} / 2 )}^{2} \{ {cos}^{2} ( 2 π {f}_{s} t + θ ϵ ) + {sin}^{2} ( 2 π {f}_{s} t + θ ϵ ) \} + \\ {( {A}_{c} {A}_{s} / 2 )}^{} \{ cos ( 2 π {f}_{s} t + θ ϵ ) \cdot cos ( θ ϵ ) + \\ sin ( 2 π {f}_{s} t + θ ϵ ) \cdot sin ( θ ϵ ) \}\end{matrix} \qquad ( 10 )$$

The following formula (11) is obtained from aforementioned Formula (10) by the triangular function law.

Formula (10)=(Ac/2)²+(Aₛ/2)² +(A_{c}Aₛ/2)cos(2πfₛt) (11)

The first and second terms of aforementioned Formula (11) are fixed, so this is a direct current. The signal represented by Formula (11) is input to audio demodulation part (8).

Bandpass filter (41), audio FM demodulation part (42), and audio multiplexing part (43) are furnished inside audio demodulation part (8).

The output signal of addition circuit (35) is input to bandpass filter (41). The output signal of addition circuit (35) passes through bandpass filter (41) to remove the DC components, and the signal (A_{c}Aₓ/2)cos(2πfₛt) for the third term in Formula (11) is input to audio FM demodulation part (42) as the audio IF signal.

The input audio IF signal is FM demodulated by audio FM demodulation part (42) and output to audio multiplexing part (43).

FM demodulation of the secondary audio is further performed by audio multiplexing part (43) and either primary audio, secondary audio, or stereo is selected and output according to external control. The audio signal demodulated by audio multiplexing part (43) is ultimately output to the speaker.

Incidentally, with a system without countermeasures, θε that is included in the second term (Aₛ/2)cos(2πfₛt+θε) in Formula (8) will be a cause of Nyquist buzz.

The multiplied signal output from first multiplier (31) is also input to low-pass filter (9). Low-pass filter (9) removes the higher harmonic components from the multiplied signal and a video signal is ultimately produced.

Next, the errors will be examined.

Amplitude error of the signal input to addition circuit (35) and phase (timing) error should be considered primarily as error factors.

Amplitude error can be made small enough to be ignored when the circuitry of demodulation circuit (4) of this invention is integrated circuitry. Normally it is relatively easy to make it about 3%, so a comparative examination will be attempted using this value.

First, the effect of amplitude error is represented by the coefficient A. The third term in Formula (8) is calculated under this condition. Here, the coefficient of the third term has no relation to the error, so it is already excluded. Frequency components other than the direct current also appear in the first and second terms due to the effects of this error, and the frequency varies greatly with the frequency of the third term, and it will not be a problem since it is removed by bandpass filter (41) at a later stage.

Error occurs in the amplitude on the sin side in the third term in Formula (10). If error is evaluated when the amplitude changes from 1 to A, the third term in Formula (10) will be [Number 1]

(Third term in Formula (10))

$$\begin{matrix}( Third term in Formula ( 10 ) ) = cos ( 2 π {f}_{s} t + θ ϵ ) \cdot cos ( θ ϵ ) + \\ A \cdot sin ( 2 π {f}_{s} t + {θ}_{ϵ} ) \cdot sin ( {θ }_{ϵ} ) \\ = cos ( 2 π {f}_{s} t ) \{ {cos}^{2} ( {θ}_{ϵ} ) + A {sin}^{2} ( {θ}_{ϵ} ) \} - \\ ( 1 - A ) \cdot sin ( 2 π {f}_{s} t ) \cdot sin ( {θ}_{ϵ} ) \cdot cos ( {θ}_{ϵ} ) \\ = \sqrt{{\{ {cos}^{2} ( {θ}_{ϵ} ) + A {sin}^{2} ( {θ}_{ϵ} ) \}}^{2} + {\{ ( 1 - A ) \cdot sin ( {θ}_{ϵ} ) \cdot cos ( {θ}_{ϵ} ) \}}^{2}} \cdot \\ cos ( 2 π {f}_{s} t + {φ}_{1} )\end{matrix} \qquad ( 12 )$$

Here,

$${φ}_{1} = {tan}^{- 1} \{ \frac{( 1 - A ) \cdot sin ( {θ}_{ϵ} ) \cdot cos ( {θ}_{ϵ} )}{{cos}^{2} ( {θ}_{ϵ} ) + A {sin}^{2} ( {θ}_{ϵ} )} \}$$

For the FM signal, fluctuation in the direction of amplitude is eliminated by a limiter during demodulation, so the amplitude component in the formula above need not be considered.

For evaluation of error, the terms θε in Formula (8) and φ₁in Formula (12) may be compared.

θε changes cyclically as discussed above. If calculated, its value is around 2° at maximum. Using A=0.97 when this value and error of 3% are assumed, φ₁(term tan⁻¹) can approximate the simple formula below from the relationship

sin(θ68 )<<1, cos(θε)\mathring{R}1, 1 −A<<1, cos²(θε)+sin²(θε)\mathring{R}1 φ₁\mathring{R}tan⁻¹(1−A)·sin(θε)\mathring{R}(1−A)·θε (14)

φ₁represents the phase error produced by the amplitude error in demodulation circuit (4) of this invention. In contrast to this, θε of cos in Formula (8) is analogous to the phase error with a system without countermeasures. Comparing the magnitude of φ₁and θε, the effects of demodulation circuit (4) of this invention can be seen. From Formulas (8) and (14), it can be seen that the effect of error will be approximately (1−A) times that of a system without countermeasures with the system for demodulation circuit (4) of this invention. For example, with an amplitude error of around 3%, if A=0.97 it improves to (1−A) times =0.03 times =1/33.

Next, the phase error will be considered. For the phase error, the IC is a circuit formed on a semiconductor chip, so the wire length is short. The frequency handled is also at most around

10 MHz, so it can be ignored after first and second multipliers (31) and (32). Thus, the phase error of phase shifter (24) will be examined.

Assuming amplitude error is zero for the sake of simplicity, it will be assumed that the error occurs on the sin side in the third term in Formula (10) the same as when the amplitude error was examined. Here, the phase error is represented by θₒ, and when the phase error on the sin side changes from θ_{ε}to θ_{ε}+θεₒ,

$$\begin{matrix}( Third term in Formula ( 10 ) ) = cos ( 2 π {f}_{s} t + θ ϵ ) \cdot cos ( θϵ ) + \\ sin ( 2 π {f}_{s} t + θ ϵ + {θ}_{o} ) \cdot sin ( θϵ + {θ}_{o} ) \\ = cos ( 2 π {f}_{s} t ) \cdot {cos}^{2} ( θ ϵ ) - \\ sin ( 2 π {f}_{s} t ) \cdot sin ( θ ϵ ) \cdot cos ( θ ϵ ) + \\ sin ( 2 π {f}_{s} t ) \{ cos ( θϵ ) \cdot sin ( θ ϵ ) \cdot {cos}^{2} ( {θ}_{o} ) + \\ {cos}^{2} ( θ ϵ ) \cdot cos ( {θ}_{o} ) \cdot sin ( {θ}_{o} ) - \\ {sin}^{2} ( θ ϵ ) \cdot sin ( {θ}_{o} ) \cdot cos ( {θ}_{o} ) + \\ cos ( θ ϵ ) \cdot sin ( θϵ ) \cdot {sin}^{2} ( {θ}_{o} ) \} + \\ cos ( 2 π {f}_{s} t ) \{ {sin}^{2} ( θϵ ) \cdot {cos}^{2} ( {θ}_{o} ) + \\ {cos}^{2} ( θ ϵ ) \cdot {sin}^{2} ( {θ}_{o} ) + \\ 2 sin ( θϵ ) \cdot cos ( θϵ ) \cdot sin ( {θ}_{o} ) \cdot cos ( {θ}_{o} ) \}\end{matrix} \qquad ( 15 )$$

θₒ is actually the value within about 3° and θ_{ε}is less than 2° as mentioned above, so an approximation as below can be used for Formula (15).

sin(θε)\mathring{R}θε

COS(θε) \mathring{R}1

sin(θₒ)\mathring{R}θₒ

cos(θₒ)\mathring{R}1

Thus aforementioned Formula (15) will be

[Number 2]

(Formula (15))

$$\begin{matrix}( Formula ( 15 ) ) = cos ( 2 π {f}_{s} t ) ( 1 + {θ}_{ϵ}^{2} + {θ}_{o} + 2 {θ}_{ϵ} {θ}_{o} ) + \\ sin ( 2 π {f}_{s} t ) ( {θ}_{o} - {θ}_{ϵ}^{2} {θ}_{o} - {θ}_{ϵ} {θ}_{o}^{2} ) \\ = \begin{matrix}\sqrt{{( 1 + {θ}_{ϵ}^{2} + {θ}_{o}^{2} + 2 {θ}_{ϵ} {θ}_{o} )}^{2} + {( {θ}_{o} - {θ}_{ϵ}^{2} {θ}_{o} - {θ}_{ϵ} {θ}_{o}^{2} )}^{2}} \cdot \\ cos ( 2 π {f}_{s} t + {φ}_{2} )\end{matrix}\end{matrix} \qquad ( 16 )$$

Here,

$${φ}_{1} = {tan}^{- 1} {θ}_{o} - {θ}_{ϵ}^{2} {θ}_{o} - \frac{{θ}_{ϵ} {θ}_{o}^{2}}{1 + {θ}_{ϵ}^{2} + {θ}_{o}^{2} + 2 {θ}_{ϵ} {θ}_{o}} \qquad ( 17 )$$

When θₒ=3° and θ_{ε}fluctuates between −2 and +2° φ₂ is a constant component of 2.970° and has a fluctuation component of −0.017 to +0.0170° . A constant component does not affect the frequency of a frequency modulated wave. Thus the fluctuation component is important. Comparing φ₂ with θ_{ε(maximum} 2°), it can be seen that it is small: about 1/117.

From the examination above, it can be seen that of the errors with demodulation circuit (4) of this invention, the phase error is dominant, and its magnitude can be improved to about 1/33(30 db ) when compared to a system without countermeasures.

Since, in actual use, an improvement of around 20 dB (1/10) can be reliably realized, this invention has sufficient effect.

Next, an example of another demodulation circuit of this invention will be explained.

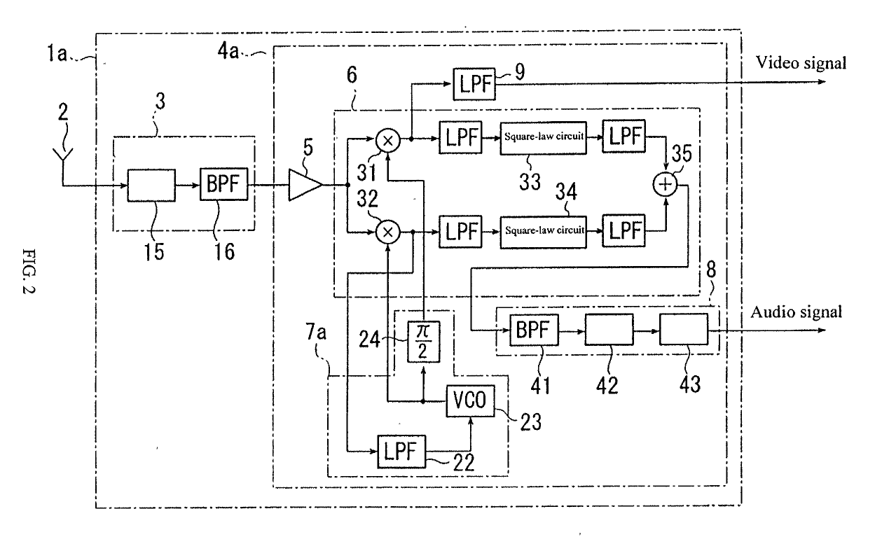

Symbol (1a) in FIG. 2 represents a television receiving device using another demodulation circuit (4a). In this demodulation circuit (4a), multiplier (21) in carrier wave reproduction part (7a) is omitted, and a PLL loop is constituted in its place with second multiplier (32), low-pass filter (22), and VCO (23). The circuit scale can be made smaller with demodulation circuit (4a) since one multiplier has been omitted.

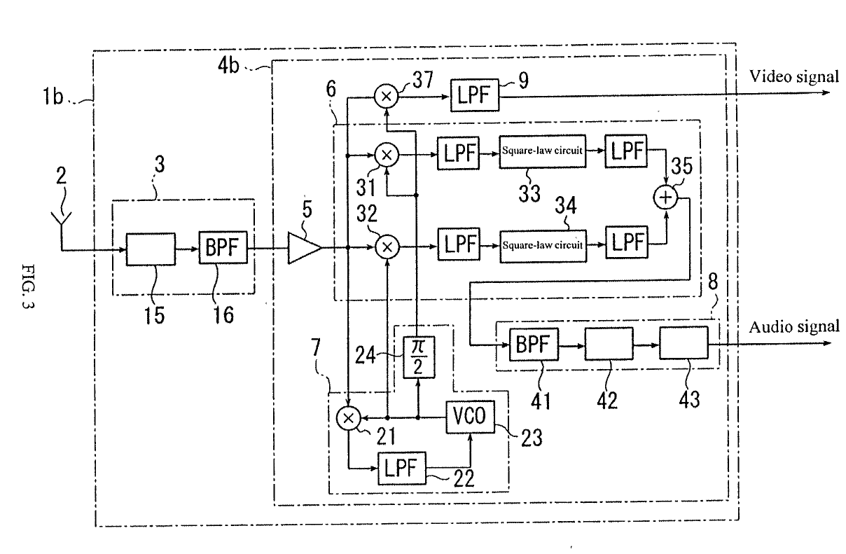

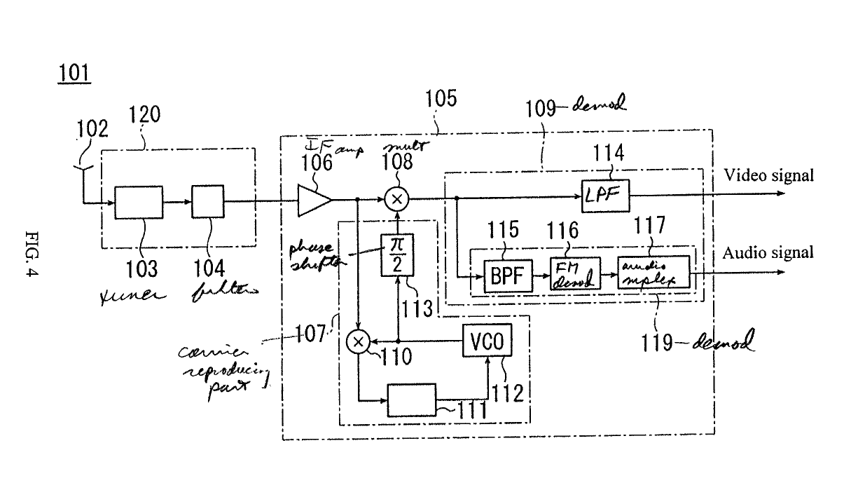

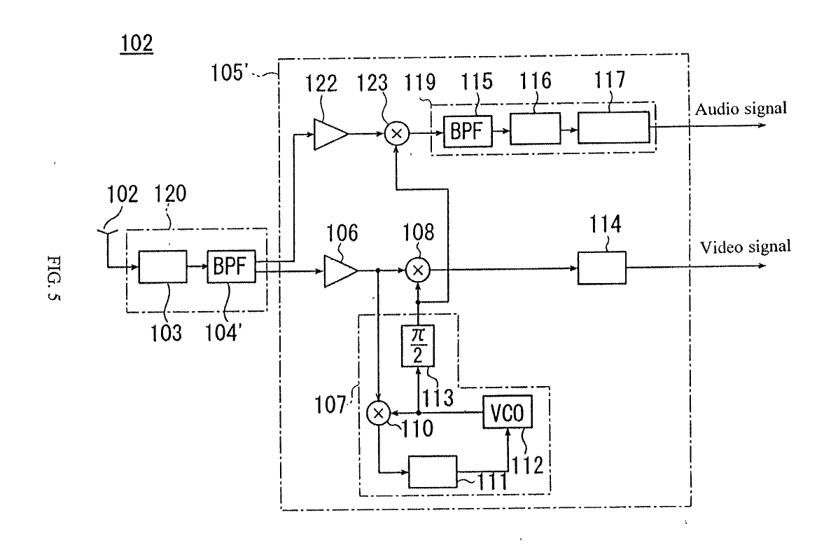

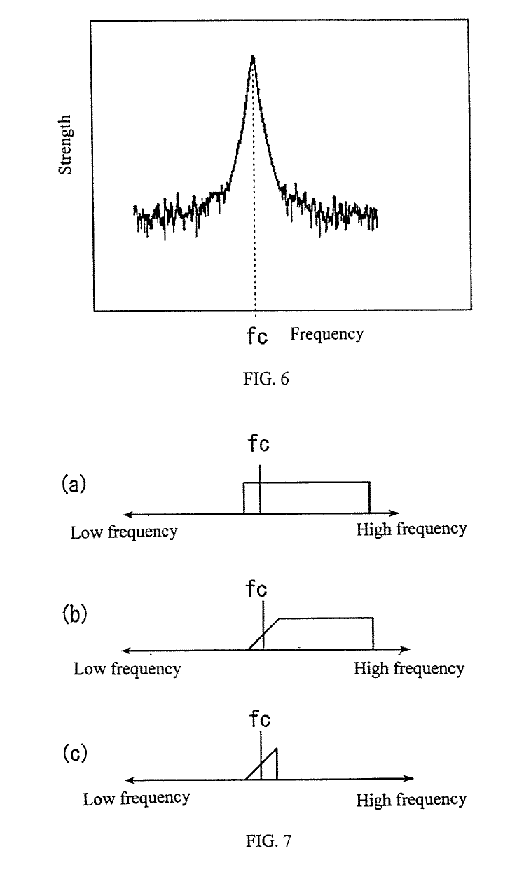

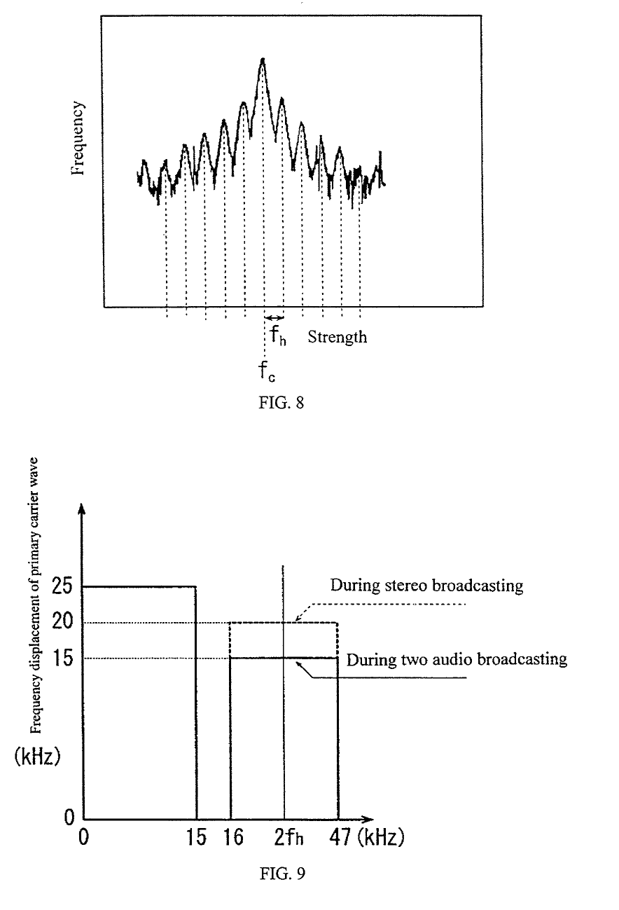

Symbol (1b) in FIG. 3 is an example of a television receiving device using still another example of a demodulation circuit (4b) of this invention.

With this demodulation circuit (4b), multiplier (37) for video reproduction is funnished. The output of phase shifter (24) and the output of IF amp (5) are multiplied separately from first multiplier (31), they are passed through low-pass filter (9), and a video signal is produced. With this demodulation circuit (4b), the circuit is expanded, but its characteristics can be optimized individually.

Here, demodulation circuits (4), (4a), and (4b) of this invention are not limited to circuits used for television receiving devices but can be applied broadly to signal reproduction devices that are affected by error, such as the Nyquist slope.

This invention can also be used as a frequency conversion circuit.

1. Frequency conversion circuit that has:
an input terminal for inputting input signals that have a first frequency signal and a second frequency signal,
a reference signal generation circuit into which the aforementioned input signal is input, and that generates a first reference signal that has the same frequency as the aforementioned first frequency signal and a second reference signal whose phase is offset π/2 from the aforementioned first reference signal,
a first multiplication circuit that multiplies the aforementioned input signal and the aforementioned first reference signal to output a first multiplied signal,
a second multiplication circuit that multiplies the aforementioned input signal and the aforementioned second reference signal to output a second multiplied signal,
a first square-law circuit that squares the aforementioned first multiplied signal to output a first square-law signal,
a second square-law circuit that squares the aforementioned second multiplied signal to output a second square-law signal,
and an addition circuit that adds the aforementioned first square-law signal and the aforementioned second square-law signal to output an addition signal.

2. Frequency conversion circuit mentioned in claim 1 where the aforementioned reference signal generation circuit has a voltage-controlled oscillator that generates the aforementioned first reference signal, a multiplier that multiplies the aforementioned input signal and the aforementioned first reference signal, a low-pass filter into which the output signal of the aforementioned multiplier is input and that outputs to the aforementioned voltage-controlled oscillator, and a phase shifter that generates the aforementioned second reference signal from the aforementioned first reference signal.

3. A demodulation circuit that has:
an input terminal into which is input an intermediate frequency signal that has a video signal and an audio signal,
a carrier signal generation circuit into which the aforementioned intermediate frequency signal is input to generate a first reference signal that has the same frequency as the carrier wave contained in the aforementioned intermediate frequency signal and a second reference signal that is displaced π/2 from the aforementioned first reference signal,
a first multiplication circuit that multiplies the aforementioned intermediate frequency signal and the aforementioned first reference signal to output a first multiplied signal,
a second multiplication circuit that multiplies the aforementioned intermediate frequency signal and the aforementioned second reference signal to output a second multiplied signal,
a first square-law circuit that squares the aforementioned first multiplied signal to output a first square-law signal,
a second square circuit that squares the aforementioned second multiplied signal to output a second square-law signal,
an addition circuit that adds the aforementioned first square-law signal and the aforementioned second square-law signal to output an addition signal,
and an audio signal demodulation part into which the aforementioned input signal is input and that demodulates the audio signal.

4. Demodulation circuit mentioned in claim 3 where the aforementioned carrier signal generation circuit has a voltage-controlled oscillator that generates the aforementioned first reference signal, a multiplier that multiplies the aforementioned intermediate frequency signal and the aforementioned first reference signal, a low-pass filter into which the output signal of the aforementioned multiple is input and that outputs to the aforementioned voltage-controlled oscillator, and a phase shifter that generates the aforementioned second reference signal from the aforementioned first reference signal.

5. Television receiving device that has a tuner into which television signals are input, a bandpass filter into which the output of the aforementioned tuner is input and that outputs intermediate frequency signals, an amplification circuit that amplifies the intermediate frequency signals output from the aforementioned bandpass filter, and the demodulation circuit mentioned in claim 3 or 4 into which the output signals of the aforementioned amplification circuit are input.
